(19) United States
(12) Patent Application Publication
(10) Pub. No.: US 2020/0265542 A1
(43) Pub. Date: Aug. 20, 2020

(54) VEHICLE RIDE SHARE ASSIST SYSTEM

(71) Applicant: HONDA MOTOR CO., LTD., Tokyo (JP)

(72) Inventors: Kuniaki MATSUSHIMA, Wako-shi (JP); Hiroyuki TANABE, Wako-shi (JP); Ryusuke TAMANAHA, Wako-shi (JP); Yasuhiro SAWADA, Wako-shi (JP)

(21) Appl. No.: 16/792,407

(22) Filed: Feb. 17, 2020

(30) Foreign Application Priority Data
Feb. 18, 2019 (JP) 2019026492

(51) Int. Cl. G06Q 50/30; G06Q 10/06; G06Q 10/02; G06F 16/28

(52) U.S. Cl. CPC G06Q 50/30; G06Q 10/06311; G06F 16/285; G06Q 10/02; G06Q 10/06315

(57) ABSTRACT

A vehicle ride share assist system includes: user terminals possessed by users; and a host server connected to the user terminals and configured to acquire ride share application information entered to the respective user terminals, the ride share application information including available vehicle information indicating whether each of the users has an available vehicle that can be used for ride share, set a plurality of drivers from the users based on the ride share application information, create a plurality of ride share groups that include the drivers respectively, create a plurality of operation schedules for the ride share groups respectively, allocate an allocated vehicle to a user who is set as one of the drivers and does not have the available vehicle, create reservation results of the ride share based on the operation schedules and information about the allocated vehicle, and send the reservation results to the user terminals.

### TECHNICAL FIELD

The present invention relates to a vehicle ride share assist system for providing a ride share service to users.

### BACKGROUND ART

Conventionally, vehicle ride share assist systems (ride share service systems) support ride share of a vehicle between a driver who plans to travel by a vehicle and a passenger who desires to travel to a destination by a vehicle of others (for example, JP2002-140399A). Ride share reduces the number of cars to be used, thereby saving energy, reducing emission of CO₂, and mitigating traffic congestion.

In the vehicle ride share assist system disclosed in JP2002-140399A, each user specifies whether he/she is a driver or a passenger (a person who does not drive) when applying for ride share. Accordingly, in some cases, the ratio between drivers and passengers is biased, which reduces a creation number of ride share groups. To solve this problem, the vehicle ride share assist system may set drivers among users who have applied for the ride share so that shortage and excess of the driver can be suppressed. However, in this manner, the user who can be a driver may be required to have an available vehicle that can be used for the ride share, and therefore, the creation number of the ride share groups may be reduced if there are few users who have the available vehicle.

### SUMMARY OF THE INVENTION

In view of such a problem of the prior art, a primary object of the present invention is to provide a vehicle ride share assist system that can increase a creation number of ride share groups.

To achieve such an object, one embodiment of the present invention provides a vehicle ride share assist system (1) including: a plurality of user terminals (2) possessed by users; and a host server (4) connected to the user terminals via a network (3) and configured to acquire ride share application information entered to the respective user terminals, the ride share application information including available vehicle information indicating whether each of the users has an available vehicle that can be used for ride share, set a plurality of drivers from the users based on the ride share application information, create a plurality of ride share groups that include the drivers respectively, create a plurality of operation schedules for the ride share groups respectively, allocate an allocated vehicle to a user who is set as one of the drivers and does not have the available vehicle, create reservation results of the ride share based on the operation schedules and information about the allocated vehicle, and send the reservation results to the user terminals.

According to this arrangement, the drivers and the ride share groups are set regardless of presence/absence of the available vehicle, so that a combination of the users can be set flexibly to increase a creation number of the ride share groups. Since the vehicle ride share assist system allocates a ridable vehicle to the user who does not have the available vehicle, the user does not need to prepare the vehicle by himself/herself.

Preferably, the vehicle ride share assist system further includes a shared vehicle managing system (7) configured to manage a reservation of a shared vehicle; and a taxi reservation system (8) configured to manage a reservation of a taxi, wherein the allocated vehicle consists of the shared vehicle or the taxi, and the host server is configured to communicate with the shared vehicle managing system to create the reservation of the shared vehicle or with the taxi reservation system to create the reservation of the taxi when the host server allocates the allocated vehicle, and the reservation result sent to the user terminal possessed by the user who is set as the one of the drivers and does not have the available vehicle includes reservation information of the shared vehicle or the taxi.

According to this aspect, it is possible to automatically allocate the shared vehicle or the taxi to the user who is set as the one of the drivers and does not have the available vehicle, and the user can check the shared vehicle or the taxi allocated to the user by using the user terminal.

Preferably, the host server is configured to create the reservation of the shared vehicle in a case where the reservation of the shared vehicle is possible and to create the reservation of the taxi in a case where the reservation of the shared vehicle is not possible and the reservation of the taxi is possible when the host server allocates the allocated vehicle.

According to this arrangement, it is possible to preferentially assign the user the shared vehicle over the taxi.

Preferably, the host server is configured to delete the ride share group which includes the user who is set as the one of the drivers and does not have the available vehicle if the host server cannot allocate the shared vehicle or the taxi to the user.

According to this arrangement, it is possible to avoid a situation that a ridable vehicle does not exist although the ride share group is created.

Preferably, the ride share application information entered to each user terminal includes intent information indicating whether the corresponding user permits allocation of the allocated vehicle to the user, and the host server is configured to allocate the allocated vehicle to the user who is set as one of the drivers and does not have the available vehicle based on the intent information.

According to this arrangement, it is possible to prevent the user from being set as the driver against his/her will.

Another embodiment of the present invention provides a vehicle ride share assist system (1) including: a plurality of user terminals (2) possessed by users; and a host server (4) connected to the user terminals via a network (3) and configured to acquire ride share application information entered to the respective user terminals, the ride share application information including available vehicle information indicating whether each of the users has an available vehicle that can be used for ride share, create a first ride share group based on the available vehicle information such that the first ride share group includes at least one user who has the available vehicle, set one of the users included in the first ride share group and has the available vehicle as a first driver, create a first operation schedule that is an operation schedule of the first ride share group, create a second ride share group from the users not included in the first ride share group, set one of the users included in the second ride share group as a second driver, create a second operation schedule that is an operation schedule of the second ride share group, allocate an allocated vehicle to the user who is set as the second driver if the user does not have the available vehicle, create reservation results of the ride share based on the first operation schedule, the second operation schedule, and information about the allocated vehicle, and send the reservation results to the user terminals.

According to this aspect, the second ride share group and the second driver are set from the users not included in the first ride share group regardless of presence/absence of the available vehicle, so that a creation number of the second ride share group can be increased. That is, a total creation number of the first ride share group and the second ride share group can be increased. Since the vehicle ride share assist system allocates a ridable vehicle to the user who does not have the available vehicle, the user does not need to prepare the vehicle by himself/herself.

Thus, according to the above aspect, it is possible to provide a vehicle ride share assist system that can increase a creation number of ride share groups.

### BRIEF DESCRIPTION OF THE DRAWINGS

FIG. 1 is a block diagram of a vehicle ride share assist system according to first and second embodiments of the present invention;

FIG. 2 is a flowchart showing a procedure of a ride share assist process according to the first embodiment;

FIG. 3 is a flowchart showing a procedure of a driver candidate setting process according to the first embodiment;

FIG. 4 is a flowchart showing a procedure of an operation schedule creating process according to the first embodiment;

FIG. 5 is a flowchart showing a procedure of an allocated vehicle reservation process according to the first embodiment;

FIG. 6 is a flowchart showing a procedure of a ride share assist process according to the second embodiment;

FIG. 7 is a flowchart showing a procedure of a first driver candidate setting process according to the second embodiment; and

FIG. 8 is a flowchart showing a procedure of a second driver candidate setting process according to the second embodiment.

### DESCRIPTION OF THE PREFERRED EMBODIMENT(S)

In the following, a vehicle ride share assist system 1 according to first and second embodiments of the present invention is described with reference to the appended drawings. For members (users) of a specific organization (a business, a government office, a sports club, a nursing home, a shopping center, or the like), the vehicle ride share assist system 1 provides a service to assist ride share of a vehicle at a time of traveling. For example, the vehicle ride share assist system 1 provides a ride share service of the vehicle when the members of the specific organization commute in the morning or evening (when the members go to work or get away from work) and when the members travel to a specific facility.

The organization that utilizes the vehicle ride share assist system 1 according to the first and second embodiments owns a plurality of shared vehicles used by the members thereof. The shared vehicles are used for traveling of the members, such as their commute. For the ride share, the vehicle ride share assist system 1 uses the plurality of shared vehicles and the members' private vehicles (hereinafter referred to as “provided vehicles”) which the members have agreed to use for the ride share. All the users, all the shared vehicles, and all the provided vehicles are registered in the vehicle ride share assist system 1. In the vehicle ride share assist system 1, user identification numbers are set for all the users, and vehicle identification numbers are set for all the shared vehicles and all the provided vehicles.

### Configuration of the Vehicle Ride Share Assist System 1

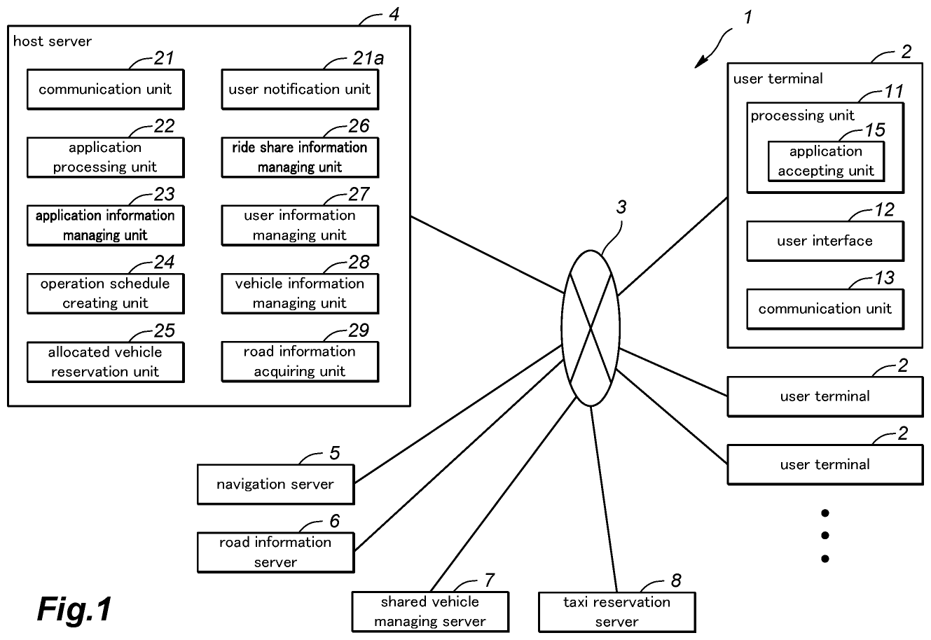

As shown in FIG. 1, the vehicle ride share assist system 1 includes a plurality of user terminals 2 and a host server 4 connected to the respective user terminals 2 via a network 3. Each user terminal 2 is possessed by the corresponding user. The host server 4 may be provided in any place, for example, in a building of the business that manages the vehicle ride share assist system 1. The network 3 is an internet, for example. The host server 4 is connected to a navigation server 5, a road information server 6, a shared vehicle managing server 7 (shared vehicle managing system), and a taxi reservation server 8 (taxi reservation system) via the network 3.

Each user terminal 2 includes a processing unit 11 for executing an application software, a user interface 12 that displays an entry screen and a message and accepts an entry operation by each user, and a communication unit 13 for communicating with the host server 4 via the network 3. For example, each user terminal 2 may consist of a smart phone, a tablet PC, a cell phone, a personal digital assistant (PDA), or the like. The processing unit 11 of each user terminal 2 includes an application accepting unit 15 that accepts a ride share application according to an entry operation of each user. When the application accepting unit 15 accepts the ride share application, the application accepting unit 15 requests each user to enter the user identification number, a desired boarding point, a desired destination, a desired boarding time, and available vehicle information (the vehicle identification number of an available vehicle). The available vehicle is defined as a vehicle that the user as a driver can operate from the desired boarding point in the ride share that the user has applied for, and includes the shared vehicle and the provided vehicle. For example, a vehicle corresponds to the available vehicle if the vehicle is parked in the vicinity of the desired boarding point selected by the user and the user possesses a key, an authentication card, or the like which is necessary for using the vehicle.

The host server 4 includes a communication unit 21, a user notification unit 21a, an application processing unit 22, an application information managing unit 23, an operation schedule creating unit 24, an allocated vehicle reservation unit 25, a ride share information managing unit 26, a user information managing unit 27, a vehicle information managing unit 28, and a road information acquiring unit 29. The communication unit 21 communicates with the user terminals 2 via the network 3. The user notification unit 21a notifies information to the users via the communication unit 21. The application processing unit 22 accepts ride share applications from the users. The application information managing unit 23 stores ride share application information of the users who desire to share a ride. The operation schedule creating unit 24 creates a plurality of ride share groups by grouping the users who have applied for the ride share, and also creates operation schedules for the respective ride share groups by using the navigation server 5 arranged outside the host server 4. The allocated vehicle reservation unit 25 creates a reservation of an allocated vehicle. The ride share information managing unit 26 stores information of the ride share groups and the operation schedules created by the operation schedule creating unit 24. The user information managing unit 27 holds information of each user. The vehicle information managing unit 28 holds registered vehicle information. The road information acquiring unit 29 acquires a congestion state of a road by using the road information server 6 arranged outside the host server 4. In other embodiments, the navigation server 5 and the road information server 6 may be provided as a part of the host server 4.

The user information managing unit 27 stores user information of each user. The user information includes the user identification number, the name of each user, the address of each user, the driving skill level of each user, the history of each user as a driver, and a vehicle identification number of a provided vehicle owned by each user.

The vehicle information managing unit 28 stores the vehicle information of the shared vehicles and the provided vehicles registered as vehicles used for the ride share. The vehicle information for each registered vehicle includes the vehicle identification number, the owner, the vehicle type, the riding capacity, the fuel mileage, and the CO₂ emission amount per unit traveling distance.

The application information managing unit 23 receives the ride share application information from the application processing unit 22 and then stores the ride share application information. The ride share application information includes the user identification number of the user who have applied for the ride share, the desired boarding point of the user, the desired destination of the user, the desired boarding time of the user, the desired arriving time of the user, the available vehicle, the permission/refusal information (intent information) for the allocation of the shared vehicle to the user, and the permission/refusal information (intent information) for the allocation of a taxi to the user.

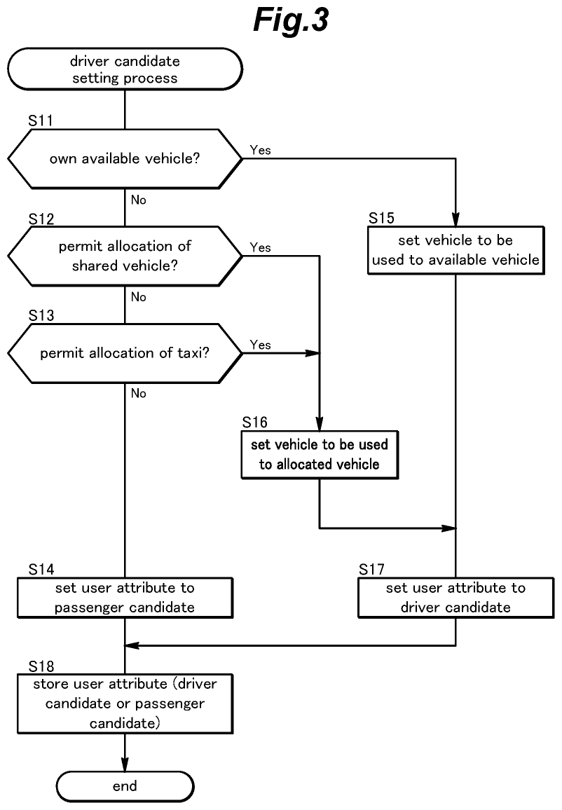

The operation schedule creating unit 24 sets the users who have applied for the ride share to either of a driver candidate or a passenger candidate (a person who does not drive) by executing the following driver candidate setting process (see FIG. 3) based on the ride share application information stored in the application information managing unit 23. Information indicating whether each user is the driver candidate or the passenger candidate is referred to as user attribute information.

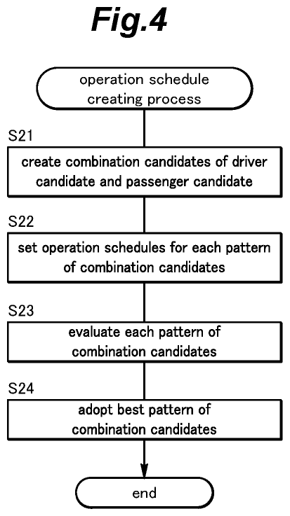

Also, the operation schedule creating unit 24 groups the users who have applied for the ride share to create a plurality of ride share groups by executing the following operation schedule creating process (see FIG. 4) based on at least the ride share application information, and sets the driver of each ride share group, the vehicle used by each ride share group, and the route of each ride share group. Further, the operation schedule creating unit 24 sets the boarding point, the destination, the boarding time, and the estimated arrival time of each user based on the route of each ride share group set thereby.

The allocated vehicle reservation unit 25 communicates with the shared vehicle managing server 7 and the taxi reservation server 8 and thereby creates a reservation of the allocated vehicle to provide the allocated vehicle for the user who is set to the driver and does not have the available vehicle. The allocated vehicle consists of the shared vehicle or the taxi. The taxi is a vehicle in which a dedicated driver different from the user rides. If the taxi is allocated to the user who is set to the driver, the user does not need to drive by himself.

The shared vehicle managing server 7 is a server that manages lending of the shared vehicles owned by the organization. The shared vehicle managing server 7 creates information (for example, success/failure of the reservation of each shared vehicle, the vehicle number of each shared vehicle to be lent, and the lending period of each shared vehicle) based on application information of the shared vehicles sent from the allocated vehicle reservation unit 25, and outputs the information to the allocated vehicle reservation unit 25.

The taxi reservation server 8 is a server that manages reservations of the taxis owned by a taxi company. The taxi reservation server 8 creates information (for example, success/failure of the reservation of each taxi, the vehicle number of each taxi to be used, and the using period of each taxi) based on application information of the taxi sent from the allocated vehicle reservation unit 25, and outputs the information to the allocated vehicle reservation unit 25.

The allocated vehicle reservation unit 25 communicates with the shared vehicle managing server 7 and the taxi reservation server 8 via the communication unit 21 to create the reservation of the shared vehicle or the taxi based on the boarding time and the estimated arrival time of the operation schedule of the ride share group in which the user who does not have the available vehicle is set to the driver. The reservation of the shared vehicle takes priority over that of the taxi. For example, the allocated vehicle reservation unit 25 creates the reservation of the shared vehicle in a case where a reservable shared vehicle is present, and creates the reservation of the taxi in a case where a reservable shared vehicle is not present and a reservable taxi is present. The allocated vehicle reservation unit 25 creates reservation failure information in a case where the allocated vehicle reservation unit 25 cannot create the reservation of the shared vehicle and the taxi for the user. As described later, information about the shared vehicle or the taxi which has been reserved and the reservation failure information are stored in the vehicle to be used as operation schedule information about the ride share group in which a target user is included. The operation schedule creating unit 24 deletes the ride share group when the operation schedule creating unit 24 fails to reserve the vehicle to be used for the ride share group.

The ride share information managing unit 26 stores the operation schedule information created by the operation schedule creating unit 24. The operation schedule information is created for each ride share group, and includes the identification number of each ride share group, the identification number of each user included in each ride share group, the identification number of each user set to the driver, the identification number of the vehicle to be used, the boarding point of each user, the destination of each user, the boarding time of each user, the estimated arrival time of each user, and the reservation information about the shared vehicle and the taxi.

The user notification unit 21a creates user operation schedule information for each user based on the operation schedule information stored in the ride share information managing unit 26, and sends the corresponding user operation schedule information to each user terminal 2 via the communication unit 21. The user operation schedule information includes the identification number of each user, the identification number of each ride share group, the identification number of the vehicle to be used, the boarding point of each user, the destination of each user, the boarding time of each user, the estimated arrival time of each user, the driver/passenger information, and the reservation information about the shared vehicle and the taxi. The driver/passenger information indicates whether the user is the driver or the passenger. The user interface 12 of each user terminal 2 displays the user operation schedule information.

### First Embodiment

### Ride Share Assist Process

In the following, a procedure of a ride share assist process of the vehicle ride share assist system 1 according to the first embodiment is described. The vehicle ride share assist system 1 sets operation periods in which the plurality of users actually share the ride, and executes the ride share assist process corresponding to each operation period. Each operation period is, for example, set at a morning commute period (from 6:00 to 10:00) or an evening commute period (from 16:00 to 20:00). In other embodiments, the operation periods may be set continuously. The vehicle ride share assist system 1 executes a plurality of ride share assist processes simultaneously corresponding to the plurality of operation periods.

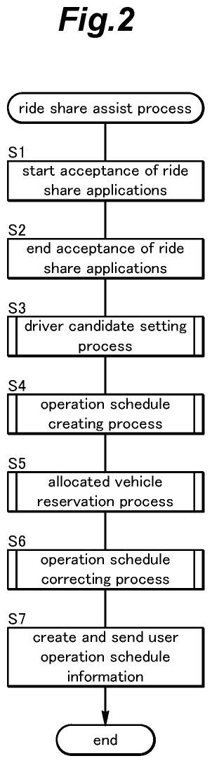

FIG. 2 shows the procedure of the ride share assist process for one operation period. First, in step S1, the application processing unit 22 of the host server 4 starts an acceptance of the ride share applications. A start time of the acceptance of the ride share applications is set to a prescribed time before a start of the operation period. For example, if the operation period is set from 6:00 to 10:00 (the morning commute period) on a certain day, the application processing unit 22 starts the acceptance of the ride share applications at 6:00 three days before that day.

At the same time, the application processing unit 22 sends an acceptance start signal to the user terminals 2, and the application accepting unit 15 of each user terminal 2 starts the acceptance of the ride share applications for a prescribed operation period. Thereby, each user can enter the ride share application for the prescribed operation period to each user terminal 2. The application accepting unit 15 requests each user to enter the ride share application information that includes the user identification number, the desired boarding point, the desired destination, the desired boarding time, the vehicle identification number of the available vehicle, the permission/refusal information for the allocation of the shared vehicle, and the permission/refusal information for the allocation of the taxi. In other embodiments, information such as the user identification number, the desired boarding point, the desired destination, the vehicle identification number of the shared vehicle (available vehicle), the permission/refusal information for the allocation of the shared vehicle, and the permission/refusal information for the allocation of the taxi may be obtained by referring to data stored in each user terminal 2, the user information managing unit 27, and the vehicle information managing unit 28, and thereby an entry information of such information may be omitted. Further, the application accepting unit 15 may omit to accept an entry of information about the permission/refusal information for the allocation of the shared vehicle and the permission/refusal information for the allocation of the taxi in a case where the vehicle identification number of the available vehicle is entered. Information entered by the user is sent to the host server 4 and stored in the application information managing unit 23.

Next, in step S2, the application processing unit 22 ends the acceptance of the ride share applications after a prescribed period from the start time of the acceptance of the ride share applications and before the start time of the operation period. For example, if the operation period is set from 6:00 to 10:00 (the morning commute period) on a certain day, the application processing unit 22 ends the acceptance of the ride share applications at 18:00 on a previous day. At the same time, the application processing unit 22 sends an acceptance end signal to the user terminals 2, and the application accepting unit 15 of each user terminal 2 ends the acceptance of the ride share applications for the prescribed operation period. Thereafter, each user cannot enter the ride share application for the prescribed operation period.

Next, in step S3, the operation schedule creating unit 24 executes the driver candidate setting process based on the ride share application information of each user. By this process, the driver candidates are set from the users who have applied for the ride share. The driver candidate setting process is described later. In this process, the users who are not set to the driver candidates are set to passenger candidates (persons who do not drive). Also, in this process, the available vehicle or the allocated vehicle is set to the vehicle to be used by each user set to the driver candidate. The allocated vehicle is a virtual vehicle which each user does not actually have and is a vehicle to be allocated to each user after each ride share group is created. The allocated vehicle consists of the shared vehicle or the taxi. Prescribed values are set for the riding capacity and the fuel mileage of the allocated vehicle, since the allocated vehicle is not specified until the following allocated vehicle reservation process is completed. The operation schedule creating unit 24 makes the application information managing unit 23 store the user attribute information indicating whether each user is the driver candidate or the passenger candidate and information about the vehicle to be used by the user set to the driver candidate.

Next, in step S4, the operation schedule creating unit 24 executes the following operation schedule creating process (see FIG. 4) based on at least the ride share application information. By the operation schedule creating process, the operation schedule creating unit 24 sets the plurality of ride share groups that include the plurality of users, and sets the driver of each ride share group, the route of each ride share group, the boarding point of each user, the destination of each user, the boarding time of each user, and the estimated arrival time of each user. The operation schedule creating unit 24 makes the ride share information managing unit 26 store the information set in this way as operation schedule information.

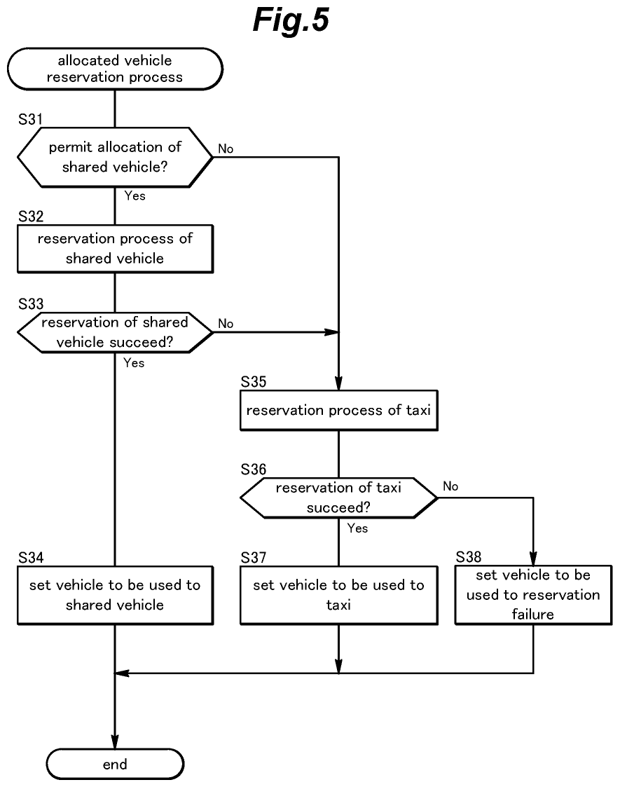

Next, in step S5, the allocated vehicle reservation unit 25 executes the following allocated vehicle reservation process (see FIG. 5). By the allocated vehicle reservation process, the shared vehicle or the taxi is reserved for and allocated to the user whose vehicle to be used is the allocated vehicle, based on the operation schedule information and the ride share application information.

Next, in step S6, the operation schedule creating unit 24 executes an operation schedule correcting process to correct the operation schedule information based on the vehicle to be used. For example, the operation schedule creating unit 24 deletes the ride share group which is provided with the user as a driver whose vehicle to be used cannot be reserved (whose vehicle to be used is not present). Thereby, the ride share group without the vehicle to be used is not created, so that the users are not confused.

Next, in step S7, the user notification unit 21a creates the user operation schedule information for each user based on the operation schedule information stored in the ride share information managing unit 26, and sends the corresponding user operation schedule information to each user terminal 2 via the communication unit 21. Thereby, each user can confirm his/her own user operation schedule information by each user terminal 2. The user operation schedule information includes information about the shared vehicle or the taxi which has been allocated. Thereby, each user can check the shared vehicle or the taxi which has been allocated by using each user terminal 2.

### Driver Candidate Setting Process

FIG. 3 is a flowchart showing a procedure of the driver candidate setting process. The driver candidate setting process is executed by the operation schedule creating unit 24 of the host server 4. The driver candidate setting process is respectively executed for all the users who have applied for the ride share. First, in step S11 of the driver candidate setting process, the operation schedule creating unit 24 determines whether the user owns (uses) the available vehicle based on the ride share application information. The available vehicle includes the shared vehicle and the provided vehicle. This determination is made based on information about the available vehicle included in the ride share application information. In a case where the operation schedule creating unit 24 determines that the user owns the available vehicle (in a case where the determination in step S11 is Yes), the operation schedule creating unit 24 sets the vehicle to be used to the available vehicle (S15), and sets the user attribute to the driver candidate (S17).

In a case where the operation schedule creating unit 24 determines that the user does not own the available vehicle (in a case where the determination in S11 is No), the operation schedule creating unit 24 determines whether the user permits the allocation of the shared vehicle to the user (S12). This determination is made based on the permission/refusal information for the allocation of the shared vehicle included in the ride share application information. In a case where the operation schedule creating unit 24 determines that the user does not permit the allocation of the shared vehicle to the user (in a case where the determination in S12 is No), the operation schedule creating unit 24 determines whether the user permits the allocation of the taxi to the user (S13). In a case where the operation schedule creating unit 24 determines that the user permits the allocation of the shared vehicle to the user (in a case where the determination in S12 is Yes) or in a case where the operation schedule creating unit 24 determines that the user permits the allocation of the taxi to the user (in a case where the determination in S13 is Yes), the operation schedule creating unit 24 sets the vehicle to be used to the allocated vehicle (S16), and sets the user attribute to the driver candidate (S17). In a case where the operation schedule creating unit 24 determines that the user does not permit the allocation of the taxi to the user (in a case where the determination in S13 is No), the operation schedule creating unit 24 sets the user attribute to the passenger candidate (S14).

The user attribute (the passenger candidate or the driver candidate) and the vehicle to be used set by the operation schedule creating unit 24 are stored in the application information managing unit 23 after the process of step S14 or S17 is completed (S18).

### Operation Schedule Creating Process

FIG. 4 is a flowchart showing a procedure of the operation schedule creating process. The operation schedule creating process is executed by the operation schedule creating unit 24 of the host server 4. First, in step S21 of the operation schedule creating process, the operation schedule creating unit 24 creates combination candidates of the driver candidate and the passenger candidate. The combination candidates includes a plurality of patterns, and each pattern includes a plurality of ride share group candidates. Each ride share group candidate includes one driver and zero or more passenger. The driver is set from the driver candidate, and the passenger is set from the driver candidate and the passenger candidate. The number of the passengers included in one ride share group candidate is set to be equal to or less than the number obtained by subtracting one from the riding capacity of the available vehicle or the allocated vehicle, which is related to the user set as a driver of the ride share group.

Next, in step S22, the operation schedule creating unit 24 sets operation schedules for each pattern of the combination candidates. Each operation schedule includes the operation route, the route length, the boarding time and the estimated arrival time of the driver and each passenger, and the operation time (the difference between the estimated arrival time and the boarding time of the driver).

Next, in step S23, the operation schedule creating unit 24 evaluates each pattern of the combination candidates, and sets an evaluation score for each pattern. This evaluation is performed based on a plurality of evaluation criteria, such as the total route length of each ride share group, the total operation time of each ride share group, the sum of the difference between the desired boarding time and the desired arrival time of each user, the number of the vehicles to be used for the ride share, the estimated total CO₂ emission amount of all the vehicles, and the ratio of the provided vehicles. The operation schedule creating unit 24 makes the evaluation score higher as the total route length of each ride share group becomes shorter, as the total operation time of each ride share group becomes shorter, as the sum of the difference between the desired boarding time and the desired arrival time of each user becomes smaller, as the number of the vehicles to be used for the ride share becomes smaller, and as the estimated total CO₂ emission amount of all the vehicles becomes smaller. Also, the operation schedule creating unit 24 makes the evaluation score higher in a case where the vehicle to be used by the user set as a driver is the available vehicle than in a case where the vehicle is the allocated vehicle. In the evaluation, the operation schedule creating unit 24 computes the evaluation score for each pattern of the combination candidate based on the plurality of evaluation criteria, and sums up the number obtained by multiplying the evaluation score by a coefficient. The coefficient can be changed as appropriate by a system administrator. The coefficient can be set as appropriate depending on the desire and need of the organization or the like that uses the vehicle ride share assist system 1. By changing the coefficient, it is possible to change the evaluation criterion to be given a high priority. For example, in a case where mitigation of the traffic congestion is set as an object, the coefficient for the number of the vehicles to be used for the ride share may be larger than the coefficients for the other evaluation criteria. In a case where reduction of CO₂ emission amount is set as an object, the coefficient for the estimated total CO₂ emission amount of all the vehicles may be larger than the coefficients for the other evaluation criteria. The evaluation criterion without a high priority may be excluded from the evaluation by setting the coefficient therefor to zero.

Next, in step S24, the operation schedule creating unit 24 adopts the best pattern having the highest evaluation score among each pattern of the combination candidates. Then, based on the best pattern, the operation schedule creating unit 24 sets the driver, the passenger, the vehicle to be used, the operation route, the route length, the boarding time and the estimated arrival time of the driver and each passenger, and the operation time.

### Allocated Vehicle Reservation Process

FIG. 5 is a flowchart showing a procedure of the allocated vehicle reservation process executed by the allocated vehicle reservation unit 25. The allocated vehicle reservation process is executed for each user whose vehicle to be used is the allocated vehicle, based on the operation schedule information. In the allocated vehicle reservation process, the allocated vehicle reservation unit 25 first determines whether the user permits the allocation of the shared vehicle to the user, based on the permission/refusal information for the allocation of the shared vehicle to the target user (S31).

In a case where the allocated vehicle reservation unit 25 determines that the user permits the allocation of the shared vehicle to the user (in a case where the determination in S31 is Yes), the allocated vehicle reservation unit 25 executes a reservation process of the shared vehicle (S32). In the reservation process of the shared vehicle, the allocated vehicle reservation unit 25 sets a use start time and a use end time of the shared vehicle based on the operation schedule information, and creates shared vehicle reservation application information including the use start time and the use end time. Then, the allocated vehicle reservation unit 25 sends the shared vehicle reservation application information to the shared vehicle managing server 7. The shared vehicle managing server 7 processes the shared vehicle reservation application information and sends reservation success/failure information and shared vehicle reservation result information to the host server 4. The shared vehicle reservation result information includes the identification number of the shared vehicle to be lent. For example, the shared vehicle managing server 7 may refer to lending information of the shared vehicle based on the shared vehicle reservation application information, search for the shared vehicle that can be used from the use start time to the use end time, succeed in the reservation of the shared vehicle in a case where the shared vehicle that can be used is present, and create the shared vehicle reservation result information based on the identification number of the shared vehicle.

Following step S32, the allocated vehicle reservation unit 25 determines whether the reservation of the shared vehicle has succeeded based on the shared vehicle reservation result information (S33). In a case where the allocated vehicle reservation unit 25 determines that the reservation of the shared vehicle has succeeded (in a case where the determination in S33 is Yes), the allocated vehicle reservation unit 25 sets the vehicle to be used to the shared vehicle (S34). For example, the allocated vehicle reservation unit 25 may set the identification number of the shared vehicle as information about the vehicle to be used.

In a case where the allocated vehicle reservation unit 25 determines that the user does not permit the allocation of the shared vehicle to the user (in a case where the determination in S31 is No) or in a case where the allocated vehicle reservation unit 25 determines that the reservation of the shared vehicle has not succeeded (in a case where the determination in S33 is No), the allocated vehicle reservation unit 25 executes a reservation process of the taxi (S35). In the reservation process of the taxi, the allocated vehicle reservation unit 25 sets a use start time and a use end time of the taxi based on the operation schedule information, and creates taxi reservation application information including the use start time and the use end time. Then, the allocated vehicle reservation unit 25 sends the taxi reservation application information to the taxi reservation server 8. The taxi reservation server 8 processes the taxi reservation application information and sends reservation success/failure information and taxi reservation result information to the host server 4. The taxi reservation result information includes the identification number of the taxi to be used. For example, the taxi reservation server 8 may refer to dispatch information of the taxi based on the taxi reservation application information, search for the taxi that can be used from the use start time to the use end time, succeed in the reservation of the taxi in a case where the taxi that can be used is present, and create the taxi reservation result information based on the identification number of the taxi.

Following step S35, the allocated vehicle reservation unit 25 determines whether the reservation of the taxi has succeeded, based on the taxi reservation result information (S36). In a case where the allocated vehicle reservation unit 25 determines that the reservation of the taxi has succeeded (in a case where the determination in S36 is Yes), the allocated vehicle reservation unit 25 sets the vehicle to be used to the taxi (S37). For example, the allocated vehicle reservation unit 25 may set the identification number of the taxi as information about the vehicle to be used. In a case where the allocated vehicle reservation unit 25 determines that the reservation of the taxi has not succeeded (in a case where the determination in S36 is No), the allocated vehicle reservation unit 25 sets the vehicle to be used to a reservation failure (the vehicle to be used is not present) (S38).

According to the above first embodiment, the drivers and the ride share groups are set regardless of presence/absence of the available vehicle, so that a combination of the users can be set flexibly to increase a creation number of the ride share groups. Since the vehicle ride share assist system 1 allocates a ridable shared vehicle or a ridable taxi to the user who does not have the available vehicle, the user does not need to prepare the vehicle by himself/herself. Each user can check the shared vehicle or the taxi which has been allocated by using each user terminal 2.

In the allocated vehicle reservation process, the shared vehicle is reserved preferentially over the taxi. Therefore, the use of the taxi, which is generally more expensive than that of the shared vehicle, can be suppressed.

In the driver candidate setting process, the user who does not have the available vehicle is set to the driver candidate based on the permission/refusal information for the allocation of the shared vehicle and the taxi. Accordingly, it is possible to prevent the user from being set to the driver against his/her will.

### Second Embodiment

In the following, a procedure of a ride share assist process of the vehicle ride share assist system 1 according to the second embodiment is described. In the following description of the ride share assist process according to the second embodiment, the description of the same process as the ride share assist process according to the first embodiment is omitted.

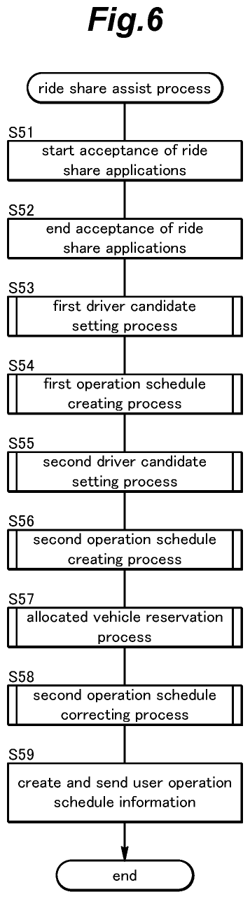

FIG. 6 is a flowchart showing the procedure of the ride share assist process for one operation period according to the second embodiment. The process of step S51 is the same as the process of step S1, and the process of step S52 is the same as the process of step S2.

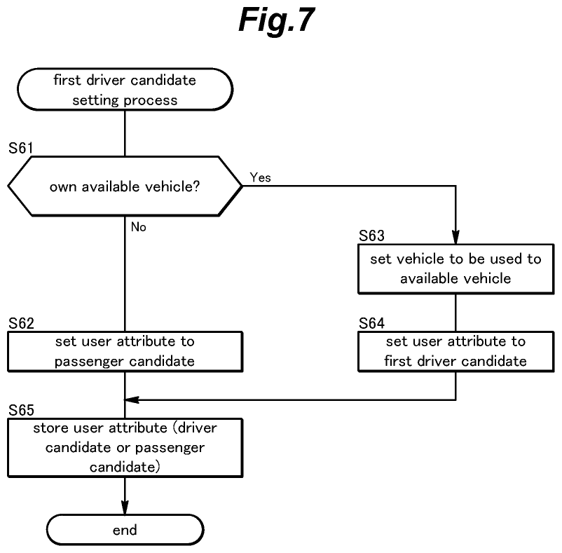

In step S53, the operation schedule creating unit 24 executes a first driver candidate setting process based on the ride share application information of each user. By this process, first driver candidates are set from the users who have applied for the ride share. The first driver candidate setting process is respectively executed for all the users who have applied for the ride share. As shown in FIG. 7, at the beginning of the first driver candidate setting process, in step S61, the operation schedule creating unit 24 determines whether the user owns (uses) the available vehicle based on the ride share application information. The available vehicle includes the shared vehicle and the provided vehicle. This determination is made based on information about the available vehicle included in the ride share application information. In a case where the operation schedule creating unit 24 determines that the user owns the available vehicle (in a case where the determination in step S61 is Yes), the operation schedule creating unit 24 sets the vehicle to be used to the available vehicle (S63), and sets the user attribute to a first driver candidate (S64). In a case where the operation schedule creating unit 24 determines that the user does not own the available vehicle (in a case where the determination in step S61 is No), the operation schedule creating unit 24 sets the user attribute to the passenger candidate (S62).

The user attribute (the passenger candidate or the driver candidate) and the vehicle to be used set by the operation schedule creating unit 24 are stored in the application information managing unit 23 after the process of step S62 or S64 is completed (S65).

Next, in step S54 of FIG. 6, the operation schedule creating unit 24 executes a first operation schedule creating process based on at least the ride share application information. The first operation schedule creating process is similar to the operation schedule creating process (S4, S21 to S24) of the first embodiment, while the first operation schedule creating process is executed by replacing the driver candidate of the operation schedule creating process with the first driver candidate. By the first operation schedule creating process, the operation schedule creating unit 24 sets a plurality of first ride share groups that include the plurality of users, and sets the driver of each first ride share group, the route of each first ride share group, the boarding point of each user, the destination of each user, the boarding time of each user, and the estimated arrival time of each user. The operation schedule creating unit 24 makes the ride share information managing unit 26 store the information set in this way as first operation schedule information.

As a result of the first operation schedule creating process, users (hereinafter referred to as “remaining users”) who cannot participate in any of the first ride share groups are generated. In step S55, the operation schedule creating unit 24 executes a second driver candidate setting process based on the ride share application information of each remaining user. By this process, the operation schedule creating unit 24 sets second driver candidates from the remaining users. The second driver candidate setting process is respectively executed for all the remaining users.

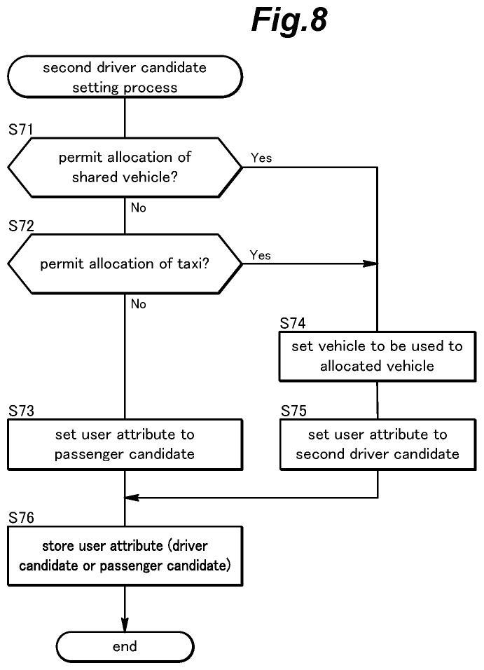

As shown in FIG. 8, at the beginning of the second driver candidate setting process, in step S71, the operation schedule creating unit 24 determines whether the user permits the allocation of the shared vehicle to the user, based on the ride share application information. This determination is made based on the permission/refusal information for the allocation of the shared vehicle included in the ride share application information. In a case where the operation schedule creating unit 24 determines that the user does not permit the allocation of the shared vehicle to the user (in a case where the determination in S71 is No), the operation schedule creating unit 24 determines whether the user permits the allocation of the taxi to the user (S72). In a case where the operation schedule creating unit 24 determines that the user permits the allocation of the shared vehicle to the user (in a case where the determination in S71 is Yes) or in a case where the operation schedule creating unit 24 determines that the user permits the allocation of the taxi to the user (in a case where the determination in S72 is Yes), the operation schedule creating unit 24 sets the vehicle to be used to the allocated vehicle (S74), and sets the user attribute to the second driver candidate (S75). In a case where the operation schedule creating unit 24 determines that the user does not permit the allocation of the taxi to the user (in a case where the determination in S72 is No), the operation schedule creating unit 24 sets the user attribute to the passenger candidate (S73).

The user attribute (the passenger candidate or the second driver candidate) and the vehicle to be used set by the operation schedule creating unit 24 are stored in the application information managing unit 23 after the process of step S73 or S75 is completed (S76).

Next, in step S56 of FIG. 6, the operation schedule creating unit 24 executes a second operation schedule creating process based on at least the ride share application information. The second operation schedule creating process is similar to the operation schedule creating process (S4, S21 to S24) of the first embodiment, while the second operation schedule creating process is executed for the users who cannot participate in any of the first ride share groups and is executed by replacing the driver candidate of the operation schedule creating process with the second driver candidate. By the second operation schedule creating process, the operation schedule creating unit 24 sets a plurality of second ride share groups that include the plurality of users, and sets the driver of each second ride share group, the route of each second ride share group, the boarding point of each user, the destination of each user, the boarding time of each user, and the estimated arrival time of each user. The operation schedule creating unit 24 makes the ride share information managing unit 26 store the information set in this way as second operation schedule information.

Next, in step S57, the allocated vehicle reservation unit 25 executes an allocated vehicle reservation process. The allocated vehicle reservation process of step S57 is similar to the allocated vehicle reservation process of step S5 (S31 to S38 of FIG. 5) of the first embodiment, while the allocated vehicle reservation process of step S57 is executed by replacing the driver candidate whose vehicle to be used is the allocated vehicle with the second driver candidate. By the allocated vehicle reservation process of step S57, the shared vehicle or the taxi is reserved for and allocated to the second driver candidate, based on the second operation schedule information and the ride share application information.

Next, in step S58, the operation schedule creating unit 24 executes a second operation schedule correcting process to correct the second operation schedule information based on the vehicle to be used. For example, the operation schedule creating unit 24 deletes the second ride share group which is provided with the user as a driver whose vehicle to be used cannot be reserved (whose vehicle to be used is not present). Thereby, the second ride share group without the vehicle to be used is not created, so that the users are not confused.

Next, in step S59, the user notification unit 21a creates the user operation schedule information for each user based on the first and second operation schedule information stored in the ride share information managing unit 26, and sends the corresponding user operation schedule information to each user terminal 2 via the communication unit 21.

According to the second embodiment, the second ride share group and the second driver are set from the users not included in the first ride share group regardless of presence/absence of the available vehicle, so that a creation number of the second ride share group can be increased. That is, a total creation number of the first ride share group and the second ride share group can be increased. Since the vehicle ride share assist system 1 allocates a ridable vehicle to the user who does not have the available vehicle, the user does not need to prepare the vehicle by himself/herself.

1. A vehicle ride share assist system, comprising:
a plurality of user terminals possessed by users; and
a host server connected to the user terminals via a network and configured to
acquire ride share application information entered to the respective user terminals, the ride share application information including available vehicle information indicating whether each of the users has an available vehicle that can be used for ride share,
set a plurality of drivers from the users based on the ride share application information,
create a plurality of ride share groups that include the drivers respectively,
create a plurality of operation schedules for the ride share groups respectively,
allocate an allocated vehicle to a user who is set as one of the drivers and does not have the available vehicle,
create reservation results of the ride share based on the operation schedules and information about the allocated vehicle, and
send the reservation results to the user terminals.

2. The vehicle ride share assist system according to claim 1, further comprising:
a shared vehicle managing system configured to manage a reservation of a shared vehicle; and
a taxi reservation system configured to manage a reservation of a taxi, wherein
the allocated vehicle consists of the shared vehicle or the taxi, and
the host server is configured to communicate with the shared vehicle managing system to create the reservation of the shared vehicle or with the taxi reservation system to create the reservation of the taxi when the host server allocates the allocated vehicle, and
the reservation result sent to the user terminal possessed by the user who is set as the one of the drivers and does not have the available vehicle includes reservation information of the shared vehicle or the taxi.

3. The vehicle ride share assist system according to claim 2, wherein
the host server is configured to create the reservation of the shared vehicle in a case where the reservation of the shared vehicle is possible and to create the reservation of the taxi in a case where the reservation of the shared vehicle is not possible and the reservation of the taxi is possible when the host server allocates the allocated vehicle.

4. The vehicle ride share assist system according to claim 2, wherein
the host server is configured to delete the ride share group which includes the user who is set as the one of the drivers and does not have the available vehicle if the host server cannot allocate the shared vehicle or the taxi to the user.

5. The vehicle ride share assist system according to claim 1, wherein
the ride share application information entered to each user terminal includes intent information indicating whether the corresponding user permits allocation of the allocated vehicle to the user, and
the host server is configured to allocate the allocated vehicle to the user who is set as one of the drivers and does not have the available vehicle based on the intent information.

6. A vehicle ride share assist system, comprising:
a plurality of user terminals possessed by users; and
a host server connected to the user terminals via a network and configured to
acquire ride share application information entered to the respective user terminals, the ride share application information including available vehicle information indicating whether each of the users has an available vehicle that can be used for ride share,
create a first ride share group based on the available vehicle information such that the first ride share group includes at least one user who has the available vehicle,
set one of the users included in the first ride share group and having the available vehicle as a first driver,
create a first operation schedule that is an operation schedule of the first ride share group,
create a second ride share group from the users not included in the first ride share group,
set one of the users included in the second ride share group as a second driver,
create a second operation schedule that is an operation schedule of the second ride share group,
allocate an allocated vehicle to the user who is set as the second driver if the user does not have the available vehicle,
create reservation results of the ride share based on the first operation schedule, the second operation schedule, and information about the allocated vehicle, and
send the reservation results to the user terminals.
